(19) United States
(12) Patent Application Publication
(10) Pub. No.: US 2011/0100566 A1
(43) Pub. Date: May 5, 2011

(54) Slat for venetian blind

(76) Inventor: A-Nan Chen, Luh-Gaang Chen (TW)

(21) Appl. No.: 12/588,975

(22) Filed: Nov. 4, 2009

(51) Int. Cl. E06B 9/386

(52) U.S. Cl. 160/236

(57) ABSTRACT

A slat for Venetian blind with a stiffer support includes at least a pliable blade and two bracing bars. The pliable blade has two sides formed respectively a first threading zone and a second threading zone that are parallel with each other. On each of the threading zones there are a plurality of threading slots spaced from one another at a selected interval to allow the bracing bars to thread through alternately up and down from one end to other end of the pliable blade. The pliable blade has two ends folding inverse to form respectively a holding portion which has holding pockets to be wedged in by the tail ends of the bracing bars to form secured holding. The blind thus formed can provide more versatile profiles and colors, and has more aesthetic appeal and added-value.

### BACKGROUND OF THE INVENTION

1. Field of the Invention

The present invention relates to a slat for Venetian blind and particularly to a slat made of a pliable blade which is stiffly supported to form versatile profiles and colors to enhance aesthetic appeal and added-value.

2. Description of the Prior Art

A conventional Venetian blind slat 1 made from a pliable sheet 10 as shown in FIG. 1 generally has two sleeves 11 and 12 at two sides inserted with two bracing bars 13 and 14. Reference of such a structure can be found in U.S. Pat. Nos. 2,187,121, 6,105,657 and 5,829,506. While the aforesaid slat structure can provide a more flexible and colorful impression than the traditional stiff slat, selection of the pliable sheet is limited. This is mainly because the sleeves 11 and 12 have to be formed by wrapping and stitching two sides of the pliable sheet 10. Fabrication is more difficult. Diversity of the side profile is restricted. Hence it still looks dull and lacks aesthetic appeal.

### SUMMARY OF THE INVENTION

In view of the aforesaid disadvantages, the present invention aims to provide a slat for Venetian blind that is made of a pliable blade and stiffly supported to form versatile profiles and colors to enhance aesthetic appeal and added-value.

The slat of the invention includes at least a pliable blade and two bracing bars. The pliable blade has two sides with a first threading zone and a second threading zone formed thereon in a parallel manner. Each threading zone has a plurality of threading slots spaced from one another at a selected interval. The two bracing bars can be threaded through the threading slots of the first threading zone and second threading zone alternately up and down from one end to other end. The pliable blade has two ends formed respectively a holding portion by folding inverse. The holding portion has a holding pocket to be wedged in by a tail end of each bracing bar. The slat thus formed can be assembled in a variety of fashions to offer versatile profiles and colors. Hence the aesthetic appeal and product added-value increase.

In one aspect the pliable blade is made from fabrics, leather, plastics, or knitting fabrics.

In another aspect the bracing bars are made from wood, bamboo, metal, glass fibers, or plastics.

In yet another aspect the holding portion is coupled with a coupling cap from an outer side. The coupling cap has an opening at one side and a holding space inside to securely hold the holding portion of the pliable blade.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a fragmentary perspective view of a conventional slat for Venetian blind.

FIG. 2 is an exploded view of the invention.

FIG. 3 is a fragmentary perspective view of the invention.

FIG. 4 is a plane view of the invention.

FIG. 5 is a cross section taken on line I-I in FIG. 4.

FIG. 6 is a cross section taken on line II-II in FIG. 4.

FIG. 7 is a cross section taken on line in FIG. 4.

FIG. 8 is a side view of the invention.

FIG. 9 is a schematic view of an embodiment of the invention.

FIG. 10 is a fragmentary exploded view of another embodiment of the invention.

FIG. 11 is a cross section of another embodiment of the invention.

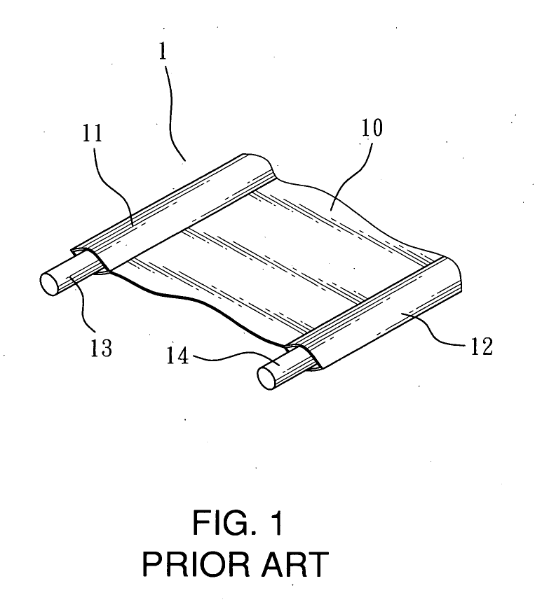

### DESCRIPTION OF THE PREFERRED EMBODIMENTS

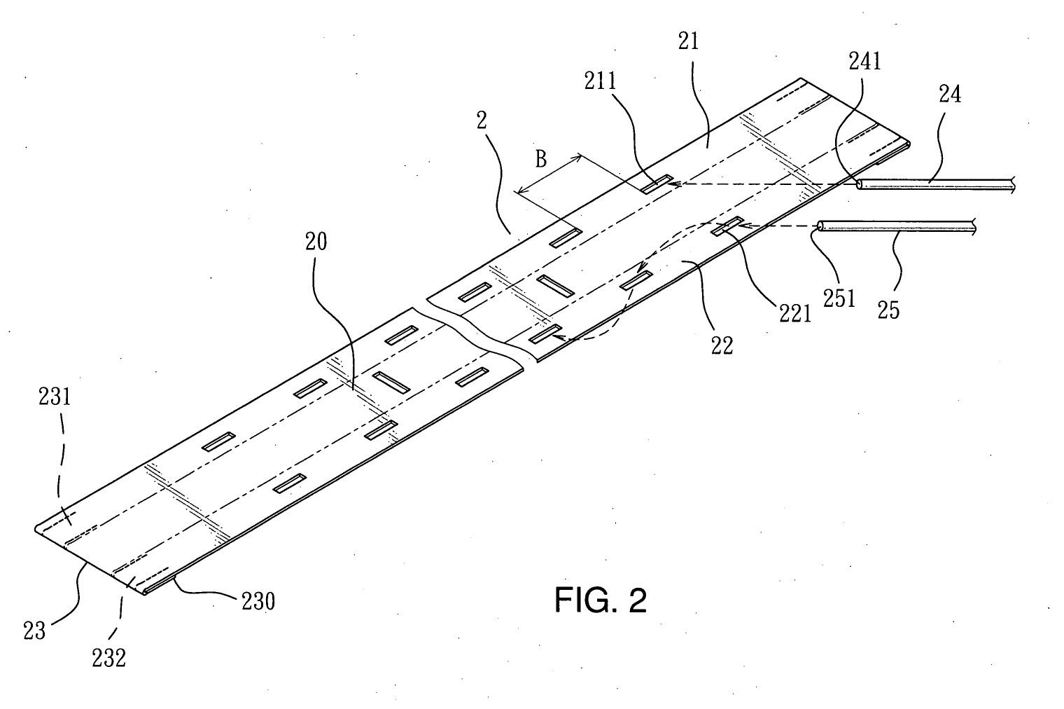

Please referring to FIG. 2, the invention provides a slat 2 for Venetian blind. It includes at least a pliable blade 20 and two bracing bars 24 and 25.

The pliable blade 20 has two sides formed respectively and longitudinally a first threading zone 21 and a second threading zone 22 that are parallel with each other. On the threading zones there are a plurality of threading slots 211 and 221 that are spaced from one another at a selected interval B (which may be set according to requirements). The pliable blade. 20 has two ends 230 folding inverse to form respectively a holding portion 23. The holding portion 23 has holding pockets 231 and 232 at two sides with an opening formed thereon.

The bracing bars 24 and 25 are elongated elements with two tail ends 241 and 251 wedged respectively in the holding pockets 231 and 232.

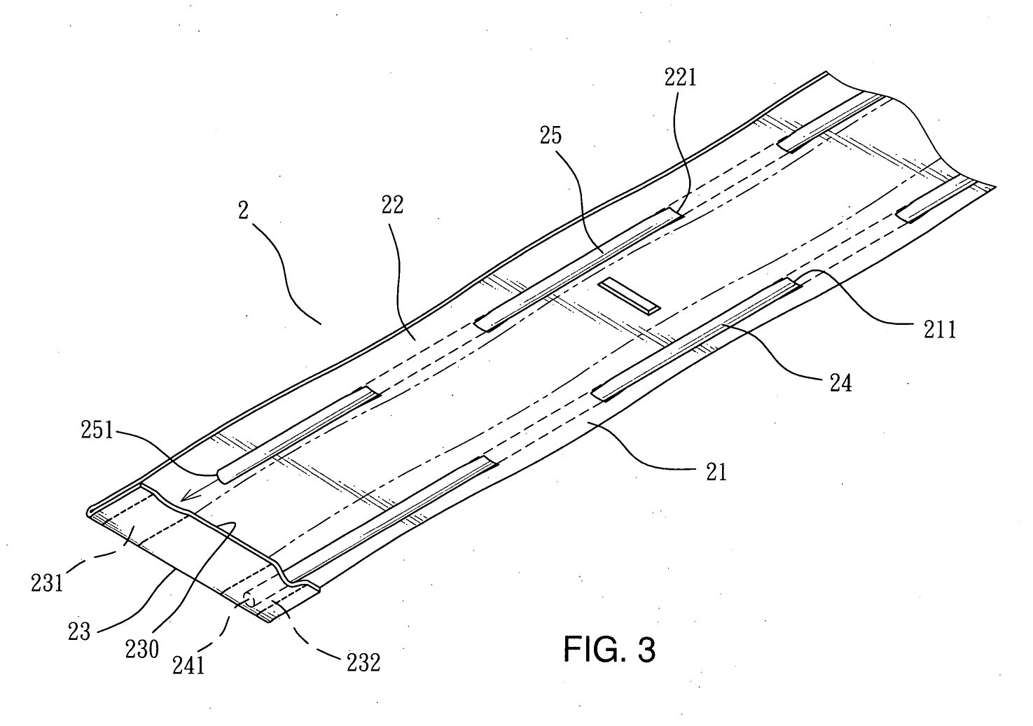

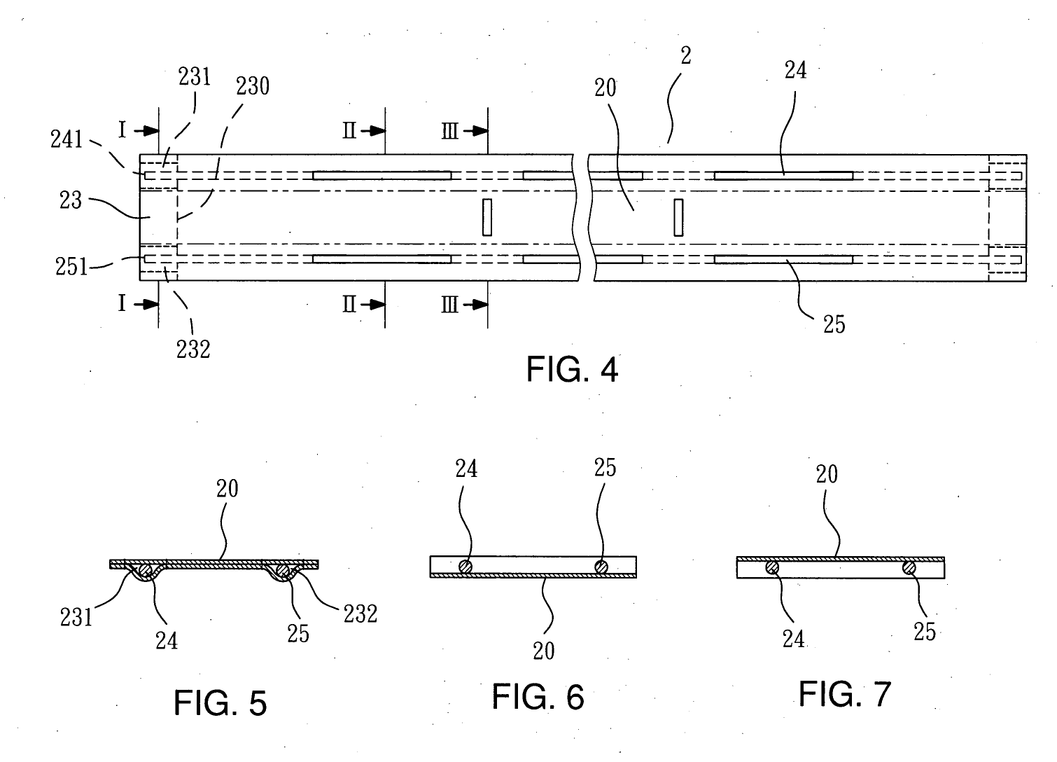

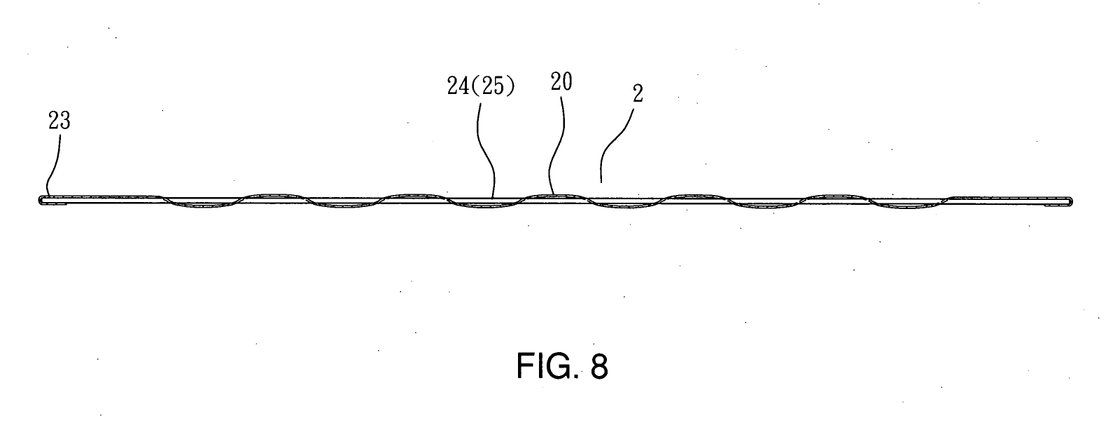

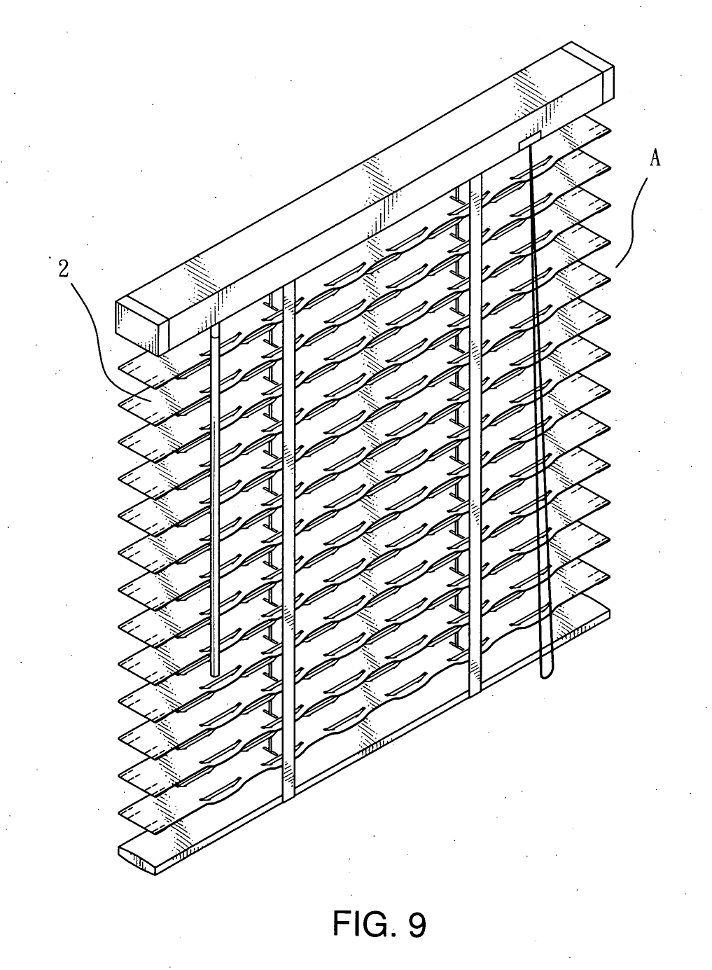

By means of the elements set forth above (also referring to FIGS. 3 through 7), for assembly, first, the bracing bars 24 and 25 are threaded through the threading slots 211 and 221 alternately up and down through the tail ends 241 and 251; then the tail ends 241 and 251 are wedged respectively in the holding pockets 231 and 232 (referring to FIGS. 3 and 8). Thereby the bracing bars 24 and 25 are disposed on the pliable blade 20 to form the slat 2 of a Venetian blind. Looking sideward, the slat has an undulate appearance. Thus the Venetian blind A consisting of a plurality of slats 2 (referring to FIG. 9) can provide more versatile profiles and has greater aesthetic appeal. It offers an improvement over the conventional Venetian blind.

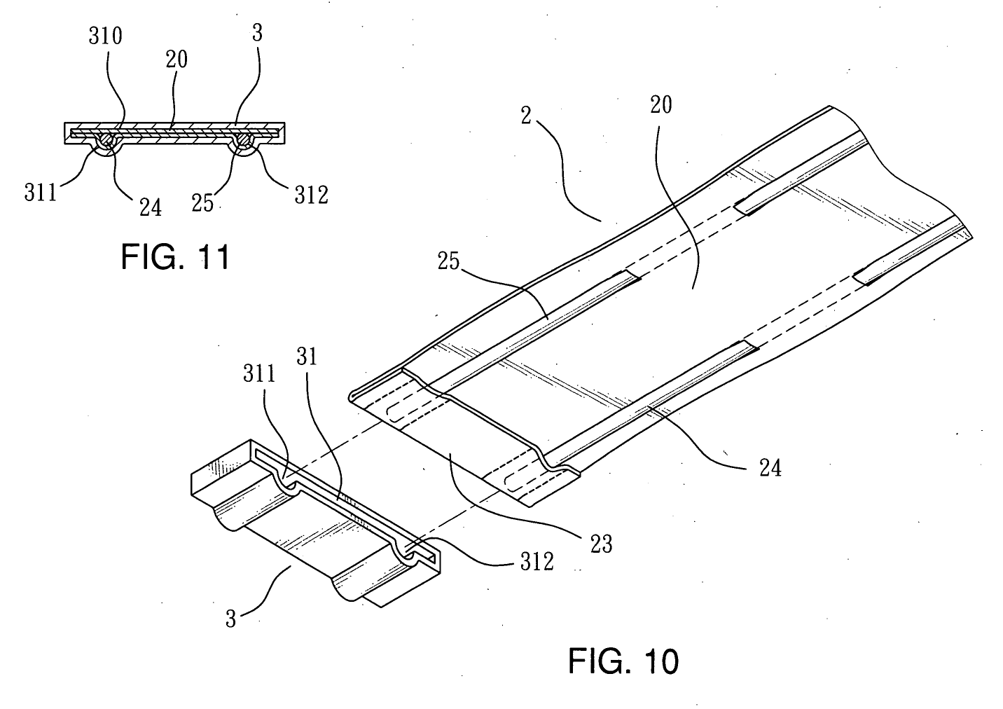

Please refer to FIGS. 10 and 11 for a second embodiment of the invention. In order to provide more secured holding of the bracing bars 24 and 25 in the holding portion 23 and further enhance ornamental effect, the holding portion 23 is coupled with a coupling cap 3 from the outer side. The coupling cap 3 has an opening 31 at one side and a holding space 310 inside with two holding troughs 311 and 312 formed therein. The tail ends 241 and 251 of the bracing bars 24 and 25 can be wedged in the holding troughs 311 and 312 to be anchored more securely.

As a conclusion, the invention provides a slat for Venetian blind that is made of a pliable blade which can be formed in versatile profiles. Thus it provides more diversity and aesthetic appeal than the conventional Venetian blind.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A slat for Venetian blind comprising at least one pliable blade and two bracing bars, wherein:
the pliable blade has two sides to form respectively and longitudinally a first threading zone and a second threading zone that are parallel with each other, each of the threading zones having a plurality of threading slots spaced from one another at a selected interval, the pliable blade further having two ends formed respectively a holding portion; and
each of the bracing bars is an elongated element and has two tail ends wedged respectively in the holding portion of the pliable blade.

2. The slat for Venetian blind of claim 1, wherein the holding portion has two holding pockets.

3. The slat for Venetian blind of claim 1, wherein the holding portion is coupled with a coupling cap from an outer side, the coupling cap having an opening at one side and a holding space inside.

4. The slat for Venetian blind of claim 3, wherein the coupling cap has two holding troughs in the holding space.
